(19) United States
(12) Patent Application Publication
(10) Pub. No.: US 2004/0200366 A1
(43) Pub. Date: Oct. 14, 2004

(54) Methods and apparatus for a food cutting device

(76) Inventors: Andrea Koerselman, San Francisco, CA (US); Hans-Christoph Haenlein, San Jose, CA (US); Sam Palmer, Menlo Park, CA (US); Annetta Papadopoulos, Palo Alto, CA (US)

Correspondence Address: SNELL & WILMER, ONE ARIZONA CENTER, 400 EAST VAN BUREN, PHOENIX, AZ, 850040001

(21) Appl. No.: 10/685,971

(22) Filed: Oct. 15, 2003

(30) Foreign Application Priority Data
Oct. 15, 2002 (EP) 02405884.4
Oct. 15, 2002 (EP) 02405885.1

(51) Int. Cl. A23N 1/00

(52) U.S. Cl. 99/537

(57) ABSTRACT

A food cutting device includes a body having two longitudinal edges and a blade configured such that its cutting edge is a predetermined distance from a removeable plate inserted therein. The device preferably includes a food holder having a guide configured to slideably connect to at least one of said longitudinal edges of the body to bring a food item safely in contact with the blade. A storage caddy, which may used in conjunction with the food cutting device, includes a housing and a pair of housing guides configured to slideably connect to the body, wherein the storage caddy includes a number of partitions or chambers to accept unused plates. At least one of the plates may include a protector designed to at least partially conceal the blade on the underside of the body.

### CROSS-REFERENCE TO RELATED APPLICATIONS

This application claims the benefit of European Application No. 02405884.4, filed Oct. 15, 2002, and European Application No. 02405885.1, filed Oct. 15, 2002.

### FIELD OF INVENTION

This invention generally relates to cutting devices, and more particularly, to a device configured to provide thin slices of vegetables, fruits, and other food items while maintaining a high level of safety.

### BACKGROUND OF THE INVENTION

Food cutting devices such as dicers, mandolins and other such slicing instruments are well known in the art. Prior art devices are described, for example, in European patent documents EP 412488A2 and EP 412489A2, as well as document EP 196550A1.

Such prior art mandolins and slicing devices are unsatisfactory in a number of respects. For example, it is typical for such devices to operate by allowing the user to move a food item laterally to engage a very sharp blade that is positioned a predetermined distance from the platen or cutting surface. The food is either held directly in the operator's hand, or is held down onto the cutting surface, and laterally translated, using a relatively unsafe food grasping device such as a hat shaped food holder.

Furthermore, as sliders generally function by allowing the sliced food to fall from the underside of the cutting device as the food is engaged by the blade, the blade is often exposed along the underside of the device. As a result, when the device is handled, the operator may find his or her fingers inadvertently contacting the blade.

Furthermore, in some prior art devices the distance of the blade from the cutting surface (and thus the thickness of the food slices) can be selected by interchangeably inserting blades, plates, or spacer components. These interchangeable blades or plates are difficult to store safely.

In light of the above, there is a need for an improved food cutting device that allows safe handling of food during slicing, allows for storage for unused components, and/or effectively protects the user from inadvertent contact with the cutting blade.

### SUMMARY OF THE INVENTION

While the way in which the present invention addresses the disadvantages of the prior art will be discussed in greater detail below, in general, the present invention provides for a cutting device which offers significant advantages over prior art devices. In accordance with one embodiment of the present invention, for example, the food cutting device includes a body having two longitudinal edges and a blade configured such that its cutting edge is a predetermined distance from a removeable plate inserted therein. The device preferably includes a food holder having a guide configured to slideably connect to at least one of said longitudinal edges of the body to bring a food item safely in contact with the blade. In accordance with another aspect of the present invention, the food cutting device includes a storage caddy having a housing and a pair of housing guides configured to slideably connect to the body, wherein the storage caddy includes a number of partitions or chambers to accept unused plates. In yet another embodiment of the present invention, at least one of the plates includes a protector designed to at least partially conceal the blade on the underside of the body.

### BRIEF DESCRIPTION OF THE DRAWINGS

The subject matter of the present invention is particularly pointed out and distinctly claimed in the concluding portion of the specification. A more complete understanding of the present invention, however, may best be obtained by referring to the detailed description and claims in connection with the drawing figures, wherein:

FIG. 1 is a perspective view of a food cutting device in accordance with one embodiment of the present invention;

FIG. 2 is a perspective view of the food cutting device of FIG. 1, showing rotation of the holder;

FIG. 3 is a front view of a holder in accordance with one embodiment of the present invention;

FIG. 4 is a front view of the device shown in FIG. 3, depicting rotation of the holder;

FIG. 5 is a perspective view of a food cutting device in accordance with the present invention;

FIG. 6 shows a perspective view of a food cutting device including a storage caddy unit;

FIG. 7 is an alternate view of the storage caddy shown in FIG. 6;

FIG. 8 is a perspective view of the underside of a food cutting device in accordance with another aspect of the present invention; and

FIG. 9 shows the device of FIG. 8 configured with a protector in accordance with another aspect of the present invention.

### DETAILED DESCRIPTION

The following description is of exemplary embodiment of the invention only, and is not intended to limit the scope, applicability or configuration of the invention in any way. Rather, the following description is intended to provide a convenient illustration for implementing various embodiments of the invention. As will become apparent, various changes may be made in the function and arrangement of the elements described in these embodiments without departing from the scope of the invention as set forth in the appended claims.

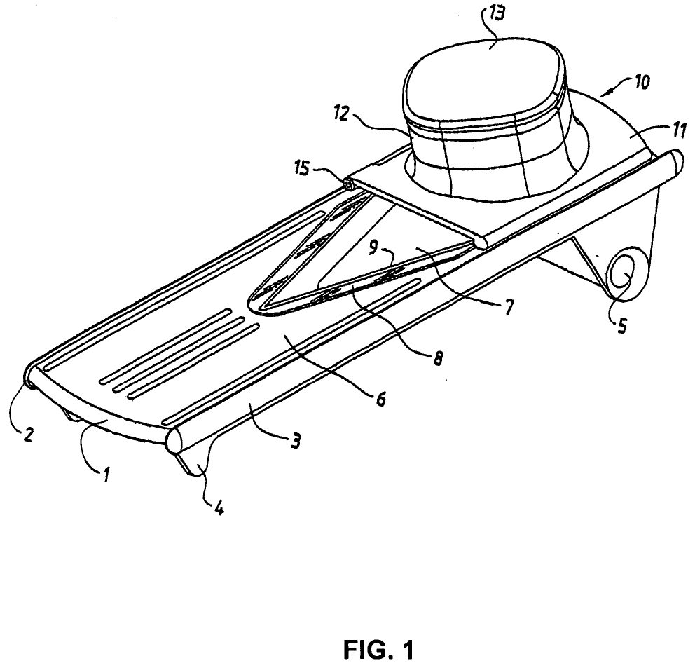

Referring to FIG. 1, an exemplary food cutting device in accordance with the present invention generally includes a device body (or simply “body”) 1 having longitudinal edges 2 and 3. Various feet 4 and 5 may also be connected to body 1 to provide stability during use. Body 1 includes a surface 6 and a blade 8 (for example, a “V”-shaped blade as shown) rigidly connected to body 1 and having a sufficiently sharp cutting edge 9. A plate (which may be removeable, as discussed below) is provided within body 1, and has a surface that is substantially parallel to surface 6 but is positioned below surface 6 by a predetermined distance, thus controlling the thickness of the resulting food slices.

A food holder (or “holder”) 10 includes a generally hollow portion 12, a baseplate 11, and a plunger 13 that may be removed and inserted into hollow portion 12 (which, during operation, functions to secure the food being sliced or cut). A hinge 15 preferably allows holder 10 to rotate with respect to body 10.

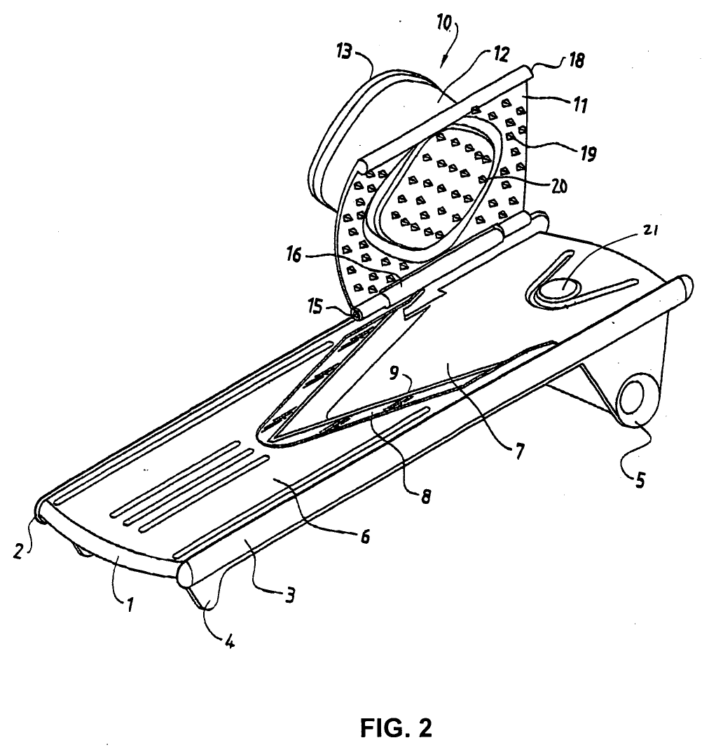

More particularly, referring now to FIG. 2, base plate and holder 10 rotate by virtue of hinge components 15 and 16. As shown, the underside of plunger 13 and/or baseplate 11 may include a plurality of protrusions 19 and 20. These protrusions, which may be shaped as points, ribs, or the like, assist in grasping the food during cutting. That is, during operation, the food item is placed within hollow portion 12 of holder 10, and plunger 13 is inserted into hollow portion 12 until the underside of plunger 13 contacts the food item. The operator than presses down lightly on plunger 13 (and/or holder 10) and moves the holder laterally in a directly substantially parallel to longitudinal edges 2 and 3. The food item slides across plate 7 until it contacts edge 9 of blade 8, whereupon the food is sliced at a thickness determined by the distance between plate 7 and blade 8.

As mentioned below, a variety of plates 7 may be provided to allow a variety of cutting thicknesses. In the illustrated embodiment, a button 21 is provided to allow plates having a corresponding hole to be inserted on top of the illustrated surface of plate 7, thus adjusting the cutting thickness. In a preferred embodiment, body 1 includes an integral plate 7 having a default thickness.

For large food items, holder 10 may be simply rotated as shown while still contacting the food item. Because of the manner in which holder 10 engages body 1 (discussed below), this slicing may be performed safely.

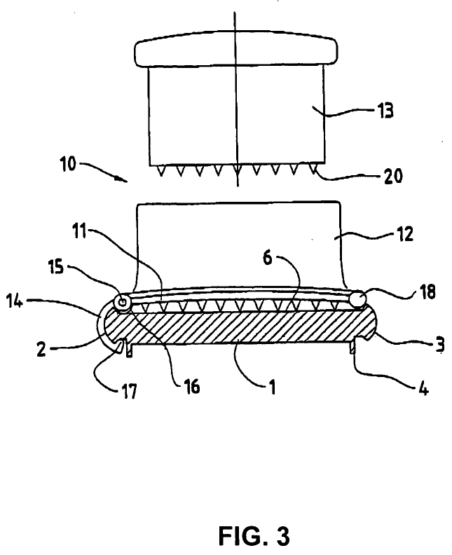

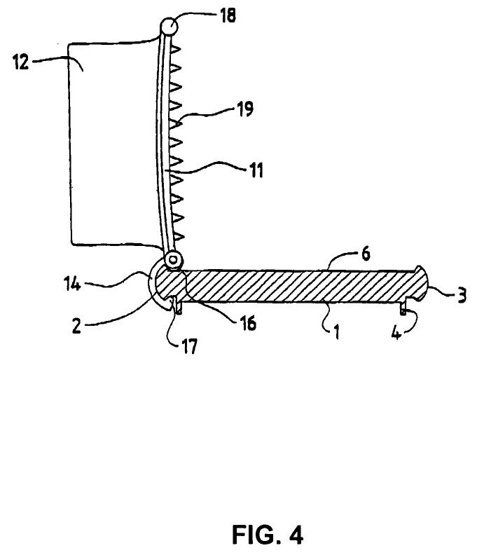

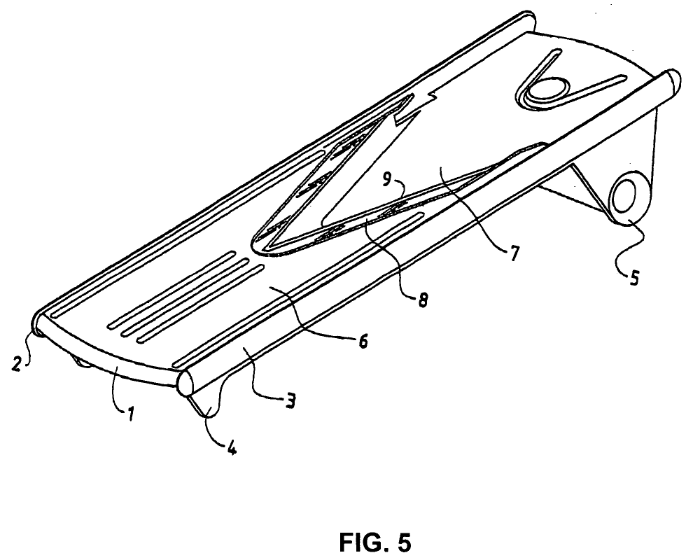

FIG. 3 shows holder 10 with plunger 13 removed from hollow region 12. As shown, A guide 14 may be rotateably connected to holder 10, wherein guide 14 engages longitudinal edge 2. Guide 14 preferably includes a latch 17 that clasps the profile of edge 2 as shown. Holder 10 may also include a edge 18 opposite to and substantially the same size as hinge 15. FIG. 4 shows the holder of FIG. 3 in its rotated position, and FIG. 5 shows the cutting device with holder 10 removed.

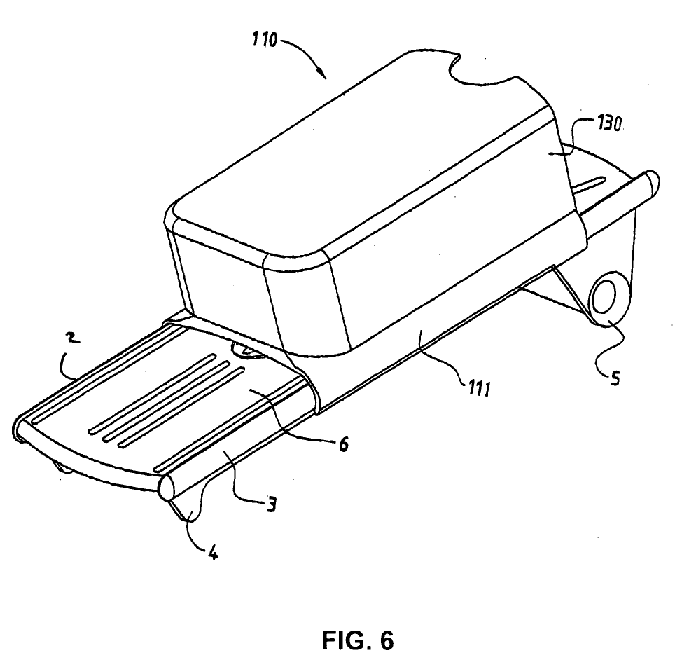

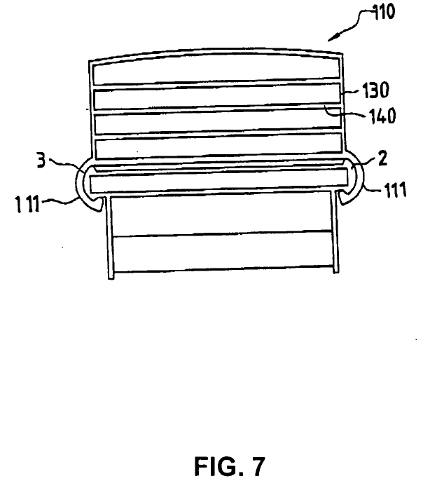

FIG. 6 shows another aspect of the present invention. A storage caddy (or “caddy”) 110 includes a removeable housing 130 and a set of housing guides 111 that grasp and slideably engage one or more edges 2 and 3. As shown in FIG. 7, caddy 110 includes one or more partitions 140 allowing one or more plates 7 to be stored within the resulting cavities, for example, during non-use of extra plates 7. As shown in this side view, housing guides 111 engage longitudinal edges 3 and 2.

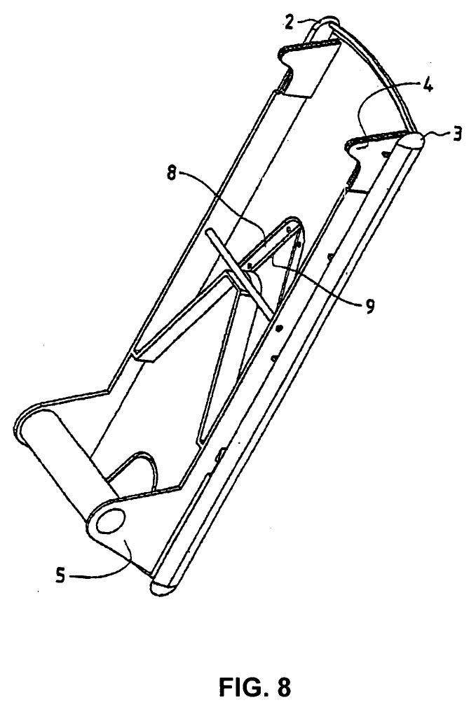

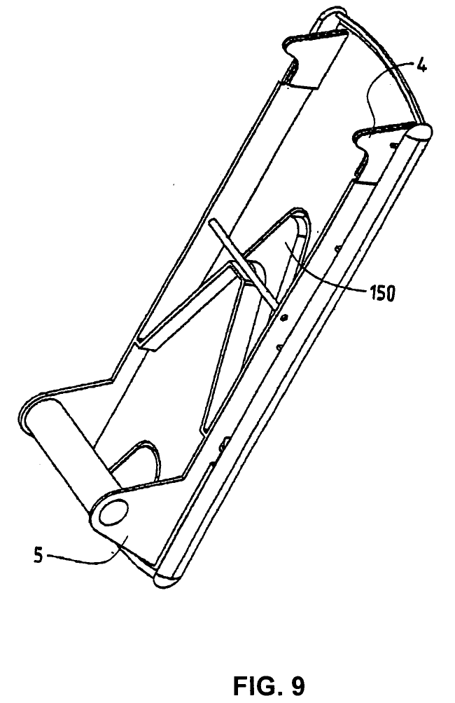

As mentioned briefly in the Background section, it is common for cutting devices to have exposed blades during storage. That is, referring to FIG. 8, the underside of a cutting device will typically expose a blade 8 having a very sharp cutting edge 9. When the operator handles the device, it is possible for the operator's fingers or thumb to inadvertently contact this edge. In accordance with one embodiment of the present invention, shown in FIG. 9, one or more of the plates 7 include a protector 150 that substantially covers the blade, thereby preventing contact during handling.

In accordance with a further embodiment of the present invention, and as a further safety precaution, protector 150, which consists of a plate that extends past the blade edge as shown in FIG. 9, is configured such that it does not fit within caddy 110. In the preferred embodiment, the plate with protector 150 is sufficiently large that it cannot be fully inserted within caddy 110. This forces the operator to insert this particular plate into body 1 during non-use, i.e., while the remaining plates are inserted within caddy 110.

Last, various principles of the invention have been described in illustrative embodiments. However, many combinations and modifications of the above-described structures, arrangements, proportions, elements, materials and components, used in the practice of the invention, in addition to those not specifically described, may be varied and particularly adapted to specific environments and operating requirements without departing from those principles.

We claim:

1. A food cutting device comprising:
a body having two longitudinal edges and a blade configured such that its cutting edge is a predetermined distance from a plate provided therein;
a food holder having a guide configured to slideably connect to at least one of said longitudinal edges of said body to thereby bring a food item in contact with said blade.

2. The food cutting device of claim 1, wherein said guide is rotateably attached to said food holder via a hinge.

3. The food cutting device of claim 1, wherein said food holder is configured to slide along an axis parallel to said longitudinal edges.

4. The food cutting device of claim 1, wherein said blade is substantially “V”-shaped.

5. The food cutting device of claim 1, wherein said plate is removeable from said body.

6. The food cutting device of claim 1, wherein said food holder includes a hollow portion and a plunger portion.

7. The food cutting device of claim 1, wherein said food holder includes a plurality of protrusions along at least one of its surfaces.

8. The food cutting device of claim 6, wherein said plunger includes a plurality of protrusions along at least one of its surfaces.

9. A food cutting device comprising:
a body having two longitudinal edges and a blade configured such that its cutting edge is a predetermined distance from a plate provided therein, wherein said plate is selected from a set of plates associated with different cutting thicknesses;
a storage caddy having a housing and a pair of housing guides, said housing guides configured to slideably connect to at least one of said longitudinal edges of said body, said storage caddy configured to store one or more of said set of plates during non-use.

10. The food cutting device of claim 9, wherein one of said plates includes a protector configured to cover said blade on the underside of said body.

11. The food cutting device of claim 10, wherein said storage caddy is configured such that said plate including a protector cannot be inserted in said caddy, but is configured to be inserted in said body during storage.
